(19) United States
(12) Patent Application Publication
(10) Pub. No.: US 2026/0341001 A1
(43) Pub. Date: Oct. 29, 2026

(54) METHOD FOR TRAINING TOOTH BEAUTIFICATION MODEL, METHOD OF TOOTH BEAUTIFICATION, ELECTRONIC DEVICE AND STORAGE MEDIUM

(71) Applicant: Beijing Baidu Netcom Science Technology Co., Ltd., Beijing (CN)

(72) Inventors: Zhiqiang WANG, Beijing (CN); Zixin TANG, Beijing (CN); Qin QIN, Beijing (CN); Yang DENG, Beijing (CN); Lihao WANG, Beijing (CN); Yu PAN, Beijing (CN)

(21) Appl. No.: 19/698,138

(22) Filed: Jun. 4, 2026

(30) Foreign Application Priority Data
Jun. 13, 2025 (CN) 202510798120.9

(51) Int. Cl. G06V 10/774; G06V 10/25; G06V 10/26; G06V 10/82; G06V 40/16

(52) U.S. Cl. CPC G06V 10/774; G06V 10/25; G06V 10/26; G06V 10/82; G06V 40/171

(57) ABSTRACT

Provided is a method for training tooth beautification model, a method of tooth beautification, an electronic device and a storage medium, relating to the fields of computer vision, model training, image processing and digital human technology. The training method includes: applying at least one image degradation algorithm to a tooth region of a sample face image to obtain a training image; inputting the training image into a neural network model having a symmetric encoder-decoder structure to output a beautified face image, where the model performs downsampling on the training image through an encoder path to extract a feature and then performs upsampling on the feature through a decoder path to reconstruct; and iteratively updating parameters of the neural network model according to a difference between the sample face image and the beautified face image to obtain the tooth beautification model.

### CROSS-REFERENCE TO RELATED APPLICATIONS

The present application claims priority to Chinese Patent Application No. CN202510798120.9, filed with the China National Intellectual Property Administration on Jun. 13, 2025, the disclosure of which is hereby incorporated herein by reference in its entirety.

### TECHNICAL FIELD

The present disclosure relates to the field of computer technologies, and in particular, to the fields of computer vision, model training, image processing and digital human technology.

### BACKGROUND

With the rapid development of artificial intelligence technology, the generation and optimization of digital content have become one of the core topics in the field of computer vision. Among them, face beautification technology, as a key technology widely used in scenarios such as social media, online conferences, video live streaming, and generation of digital human and virtual image, has continuously attracted extensive attention and research in the industry. This technology aims to improve the visual aesthetic feeling of portraits and provide users with a better interactive experience.

In a complete face beautification process, the aesthetic degree of teeth, including their definition, color and arrangement, is an important factor affecting the overall facial aesthetic feeling and naturalness. Accordingly, dedicated beautification and restoration techniques for teeth have emerged and become an important branch of face processing technology.

### SUMMARY

The present disclosure provides a method and apparatus for training a tooth beautification model, a device and a storage medium.

In a first aspect, the present disclosure provides a method for training a tooth beautification model, including:
applying at least one image degradation algorithm to a tooth region of a sample face image to obtain a training image, where a definition of the tooth region of the sample face image is higher than a definition of a tooth region of the training image;
inputting the training image into a neural network model having a symmetric encoder-decoder structure to output a beautified face image, where the model performs downsampling on the training image through an encoder path to extract a feature, and then performs upsampling on the feature through a decoder path to reconstruct; and
iteratively updating a parameter of the neural network model according to a difference between the sample face image and the beautified face image to obtain the tooth beautification model.

In a second aspect, the present disclosure provides a method of lightweight tooth beautification based on deep learning, including steps of:
inputting a face image to be processed into a pre-trained tooth beautification model; and obtaining a face image with improved definition of the tooth region from an output result of the tooth beautification model,
where the tooth beautification model is trained and obtained according to the model training method of any embodiment.

In a third aspect, the present disclosure provides an apparatus for training a tooth beautification model, including:
a degradation processing module, configured to apply at least one image degradation algorithm to a tooth region of a sample face image to obtain a training image, where a definition of the tooth region of the sample face image is higher than a definition of a tooth region of the training image;
a prediction module, configured to input the training image into a neural network model having a symmetric encoder-decoder structure to output a beautified face image, where the model performs downsampling on the training image through an encoder path to extract a feature, and then performs upsampling on the feature through a decoder path to reconstruct; and
an update module, configured to iteratively update a parameter of the neural network model according to a difference between the sample face image and the beautified face image to obtain the tooth beautification model.

In a fourth aspect, the present disclosure provides an apparatus of lightweight tooth beautification based on deep learning is provided, including:
an input module, configured to input a face image to be processed into a pre-trained tooth beautification model; and
an inference module, configured to obtain a face image with improved definition of the tooth region from an output result of the tooth beautification model,
where the tooth beautification model is trained and obtained according to the method of any embodiment.

In a fifth aspect, the present disclosure provides an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

In a sixth aspect, the present disclosure provides a non-transitory computer-readable storage medium storing a computer instruction thereon, and the computer instruction is used to cause a computer to execute the method of any embodiment of the present disclosure.

In a seventh aspect, the present disclosure provides a computer program product including a computer program that, when executed by a processor, implements the method according to any embodiment of the present disclosure.

According to the solution of the present disclosure, the definition and aesthetic degree of teeth can be effectively improved.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are included to provide a better understanding of the present solution and are not to be construed as limiting the present disclosure. In the drawings:

FIG. 1 is a schematic flowchart of a method for training a tooth beautification model according to an embodiment of the present disclosure;

FIG. 2 is a structural schematic diagram of the tooth beautification model according to an embodiment of the present disclosure;

FIG. 3 is a schematic flowchart of a method of tooth beautification according to an embodiment of the present disclosure;

FIG. 4 is a structural schematic diagram of an apparatus for training a tooth beautification model according to an embodiment of the present disclosure;

FIG. 5 is a structural schematic diagram of an apparatus of tooth beautification according to an embodiment of the present disclosure;

FIG. 6 is a block diagram of an electronic device for implementing embodiments of the present disclosure.

### DETAILED DESCRIPTION

Exemplary embodiments of the present disclosure are described below with reference to the accompanying drawings, in which various details of embodiments of the present disclosure are included to assist understanding, and which are to be considered as merely exemplary. It should therefore be understood that those skilled in the art may make various changes and modifications to the described embodiments without departing from the scope of the present disclosure. Likewise, for the sake of clarity and conciseness, well-known functions and structures are not described in detail herein.

In the related art, mainstream technical paths for realizing face and tooth beautification can be roughly summarized into the following types:
The first is a method based on traditional image processing and computer graphics. Such a method usually first locates specific facial regions including lips and teeth through face key point detection or image segmentation technology. Subsequently, a series of classic image processing algorithms, such as color space adjustment (e.g., adjusting hue, saturation and brightness in a color space), contrast enhancement, histogram equalization and the like, are applied to the identified tooth region to achieve a whitening or brightening effect.
The second is a method based on deep learning. With the emergence of a large number of image data sets and the improvement of computing power, end-to-end face beautification and image restoration using deep neural networks have become mainstream. In this technical path, generative models such as Generative Adversarial Networks (GANs) are widely used in image restoration tasks such as face super-resolution, deblurring and denoising. Such models are trained on a large number of paired or unpaired data to learn a complex mapping relationship from a low-quality or flawed input image to a high-quality, high-aesthetic output image.
The graphics-based face beautification method first needs to perform key point detection to identify different facial regions (such as eyes, cheeks, mouth, nose, etc.,), and then perform color histogram statistics, hue adjustment and the like on different regions, which is cumbersome in process and difficult to beautify the tooth region. By training the deep learning-based face and tooth beautification algorithm with a large amount of data, it is difficult for the model to focus on the tooth region, which is prone to problems such as over-whitened teeth, irregular teeth and sticky teeth.

In order to at least partially solve one or more of the above problems and other potential problems, an embodiment of the present disclosure provides a method for training a tooth beautification model. By using the technical solution according to the embodiment of the present disclosure, the definition and aesthetic degree of the tooth region in a face image can be effectively improved, while the natural feeling and identity consistency of the face can be maintained.

FIG. 1 is a schematic flowchart of a method for training a tooth beautification model according to an embodiment of the present disclosure. As shown in FIG. 1, the method includes at least steps of:
S110: applying at least one image degradation algorithm to a tooth region of a sample face image to obtain a training image, where a definition of the tooth region of the sample face image is higher than a definition of a tooth region of the training image.

In the embodiment of the present disclosure, the model training first requires preparing a data set for training. The data set contains a large number of sample face images. In the present disclosure, a sample face image refers to a high-quality, high-definition real face photo or video frame, in which especially the tooth region thereof is clear, unobstructed, and free of obvious stains or blurring. These images can be obtained from publicly available face data sets.

After obtaining the sample face image, the present disclosure applies at least one image degradation algorithm, which is intended to simulate various factors that may cause image quality degradation in the real world, such as out-of-focus, compression, low resolution and the like. By applying the algorithm to the tooth region of the sample face image, a corresponding training image can be generated. The definition of the tooth region of the training image is significantly lower than that of the original sample face image (original image), thereby forming a training pair of low-quality input and high-quality target.

S120: inputting the training image into a neural network model having a symmetric encoder-decoder structure to output a beautified face image, where the neural network model performs downsampling on the training image through an encoder path to extract a feature, and then performs upsampling on the feature through a decoder path to reconstruct.

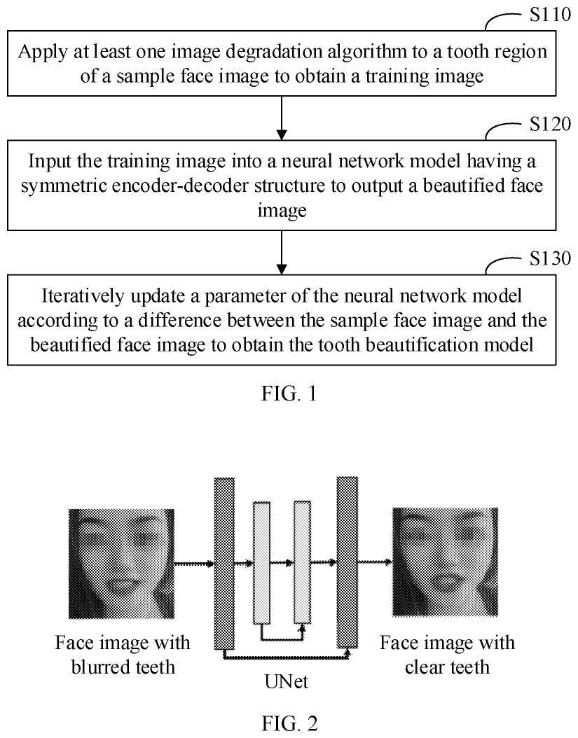

In the embodiment of the present disclosure, the generated training image is input into a preset neural network model. As shown in FIG. 2, the neural network model is a deep learning structure designed for an image-to-image conversion task, and its core feature is the symmetric encoder-decoder structure.

The encoder path, also known as the downsampling path, is responsible for receiving the training image (a face image with blurred teeth) and extracting features thereof layer by layer. In this process, a spatial size (width and height) of a feature map is gradually reduced, and abstraction and semantic level of the features are gradually deepened.

The decoder path, also known as the upsampling path, is symmetric in respect to the structure and the encoder path. The decoder path receives the deep features extracted by the encoder and performs upsampling operations layer by layer, aiming to gradually restore the details and spatial size of the image, and finally reconstructing a beautified face image (a face image with clear teeth) having the same size as the input image.

S130: iteratively updating a parameter of the neural network model according to a difference between the sample face image and the beautified face image to obtain the tooth beautification model.

In the embodiment of the present disclosure, in the iterative update stage, a difference (or referred to as loss) between the beautified face image output from the model and the original sample face image is calculated through a predefined loss function (such as L1 or L2 loss). The difference value reflects a quality of the model restoration effect. The parameters inside the neural network model are adjusted according to the difference value by using a back propagation algorithm and an optimizer. This process is repeated (i.e., iteratively updated) until an output result of the model is sufficiently close to the sample face image, thereby obtaining a trained tooth beautification model with efficient tooth beautification capability.

According to the solution of the embodiment of the present disclosure, the tooth region in the clear original image is subjected to refined and diversified degradation processing to simulate various situations of blurred teeth in a real scene, so that the model learns how to accurately reverse these degradation processes, and the trained tooth beautification model can effectively improve the definition and aesthetic degree of teeth. Meanwhile, different from a method attempting to completely regenerate teeth, the embodiment of the present disclosure only performs degradation processing on the tooth region in the original image without changing other parts of the original image, the degradation processing does not change the original tooth style (such as arrangement, shape and color basis), and the final beautification effect only improves the definition and aesthetic degree of teeth, solving the key problems of tooth distortion and large difference from the original person's style in the prior art, and maintaining the natural feeling and identity consistency of the face.

It should be particularly noted that the technical solution according to the present disclosure is essentially different from the generative restoration or image restoration technology common in the related art in terms of target problems, technical concepts and implementation paths.

First, the target problems are different: the present disclosure aims to solve the problem of image quality degradation of a face image caused by shooting conditions (such as out-of-focus, shake), transmission compression or equipment limitations. Further, during digital human live streaming, some digital human driving algorithms (such as wav2lip, DINet, MuseTalk) have the problem of generating blurred teeth. For example, inherent information such as the structure, contour and arrangement of teeth objectively exists in the image, but is expressed as blurring, noise or compression artifacts. In addition, some tooth restoration models, such as GFP-GAN and HDTR-Net, also have problems such as sticky teeth, low realism and large difference from real human style. The task of the present disclosure is to enhance the inherent information of these teeth and improve the definition and visual quality.

In contrast, typical generative restoration technologies mainly deal with the situation where content is completely missing or information is severely damaged in an image. For example, teeth in a portrait are largely blocked by a microphone, hand or other objects, or information in the tooth region is completely lost due to image damage. In such scenarios, the goal of generative restoration is to create something out of nothing, that is, to infer and create new and seemingly reasonable tooth content according to context information to fill the blank region.

Second, the technical concepts are different:
The technical concept of the present disclosure is fidelity enhancement. Its fundamental goal is to retain all personalized style features such as the original shape, arrangement, size and even slight imperfections of teeth in the original face image to the greatest extent, and only improve the definition and texture on this basis. In other words, the beautified teeth are still the teeth of the person in the face image, maintaining a high degree of identity consistency.
The core concept of generative restoration is to generate visually real, natural and aesthetically pleasing teeth, but the generated content is essentially imagined by the model according to the general tooth probability distribution learned from massive data. Therefore, the generated content may be significantly different from the user's real tooth features, and the user's unique tooth features may be replaced with a set of standard aesthetic teeth.

Finally, the implementation paths are different:
In order to achieve the goal of feature fidelity, the present disclosure adopts a training strategy of simulated degradation-reverse restoration. That is, a clear tooth image is actively subjected to programmed degradation processing such as blurring and compression, and then a model is trained to learn the precise inverse process of this degradation process. The model learns a deterministic mapping restoration process with a clear goal (original clear image).

The generative restoration model, especially the model based on Generative Adversarial Networks (GANs), has an implementation path of learning a complex data distribution. Its learning goal is not to restore a unique and real original image, but to generate any image block that can deceive the discriminator and look “real” in the missing region. The process is an uncertain probability generation process.

In a possible implementation, at S110, the applying at least one image degradation algorithm to the tooth region of the sample face image to obtain the training image further includes steps of:
S111: acquiring a face image including a tooth region as the sample face image;
S112: generating a tooth mask according to the tooth region of the sample face image; and
S113: performing image degradation processing on the tooth region of the sample face image by using at least one image degradation algorithm and the tooth mask to obtain the training image, where a definition of a tooth region of a reference face image is higher than the definition of the tooth region of the training image.

In the embodiment of the present disclosure, the tooth mask is a single-channel image having exactly the same size as the sample face image. In its pixel matrix, a pixel corresponding to a tooth position in the original image has a specific value (e.g., 1 or 255), and all non-tooth position pixels have another value (e.g., 0). The tooth mask functions to accurately calibrate a range of the tooth region to be processed.

Selective image degradation processing is performed on the tooth region by using the tooth mask in combination with at least one image degradation algorithm. Specifically, the effect of the degradation algorithm is only applied to the pixel region with a mask value of 1, while the region with a mask value of 0 keeps the original pixel of the sample face image unchanged. In this way, the training image is finally obtained in which only the tooth part is blurred and other parts of the face (such as skin, eyes and hair) remain high-definition.

The definition can be determined by image quality evaluation parameters well known to those skilled in the art, such as Laplacian variance, sum of gradient amplitudes or signal-to-noise ratio of the image.

According to the solution of the embodiment of the present disclosure, precise region control of image degradation processing is realized by using the tooth mask. This enables the model to fully focus on learning the restoration of the tooth region during training without being disturbed by changes in other regions of the face, thereby significantly improving the pertinence of training and the final beautification effect, and ensuring that the beautification process does not affect non-tooth regions.

In a possible implementation, at S112, the generating the tooth mask according to the tooth region of the sample face image includes:
determining a mouth key point region from the sample face image through face key point detection; and
segmenting a tooth part within the mouth key point region to obtain the tooth mask.

In the embodiment of the present disclosure, the face key point detection technology is applied to the sample face image. This technology is a mature computer vision technology, which can automatically recognize dozens of key points on a face, such as an eye corner, a nose tip and a mouth corner, by using a pre-trained model (such as a model in the Dlib library). Through this technology, a series of key points representing the mouth contour can be accurately located, thereby determining the mouth key point region.

Then, within the determined mouth key point region, an image of the tooth part is obtained through image segmentation. The image segmentation aims to divide an image into several regions with specific semantics. In this scenario, a pixel set belonging to teeth can be separated from a pixel set belonging to other parts such as a lip and an oral cavity interior in the mouth region through color threshold, region growing or a lightweight semantic segmentation model. The pixel set identified as teeth finally constitutes the required tooth mask.

According to the solution of the embodiment of the present disclosure, a fully automatic tooth region locating and segmentation process is provided without manual labeling, which greatly improves the efficiency and consistency of data preprocessing, and lays a foundation for large-scale and automatic model training.

In a possible implementation, the image degradation algorithm includes at least one of:
Gaussian blur, downsampling processing, JPEG compression processing, noise processing or color reduction processing.

In the embodiment of the present disclosure, the image degradation algorithm may be one algorithm or a combination of multiple algorithms, which simulate common image quality degradation situations in reality. Specifically, it may include:
Gaussian blur: simulating a blurring effect caused by camera out-of-focus or moving;
Downsampling processing: simulating an effect of a low-resolution image or video frame;
JPEG compression processing: simulating a block effect and artifact caused by lossy compression during network transmission or storage of an image;
Noise processing: simulating a random noise generated by a camera sensor under a low-light condition;
Color reduction processing: simulating a situation of dark and yellow teeth caused by insufficient light or improper exposure.

It should be noted that multiple different training images can be obtained from a single original image through a variety of different image degradation algorithms and a combination of several image degradation algorithms.

According to the solution of the embodiment of the present disclosure, by adopting diversified degradation strategies, the trained model can have stronger robustness and generalization ability. The model does not only learn to restore a specific kind of blurring, but can cope with complex tooth blurring problems caused by various reasons in the real world, and has a wider application scenario.

In a possible implementation, S113 of performing the image degradation processing on the tooth region of the sample face image by using at least one image degradation algorithm and the tooth mask to obtain the training image specifically includes:
reducing a size of the tooth region of the sample face image from an original size to a preset size through downsampling by using the tooth mask;
restoring the size to the original size through upsampling to obtain a first tooth region image; and
obtaining the training image according to the first tooth region image and a non-tooth region of the sample face image.

In the embodiment of the present disclosure, it is assumed that the original size of the region image is (w, h). Downsampling is performed on the tooth region image, that is, the size thereof is reduced to a preset size (w1, h1). In an example, a value range of w1 and h1 may be limited to w/4<w1<w and h/4<h1<h. For example, the size can be reduced to half or a quarter of the original.

Upsampling is then performed on the reduced tooth region image to restore the size to the original (w, h), so as to obtain the first tooth region image. In this way, the process of first reducing and then enlarging will cause loss of image information, thereby producing a blurring effect.

Finally, the processed first tooth region image is spliced with the original non-tooth region in the sample face image to form the final training image.

In an example, the downsampling processing can be realized through opencv. The calculation formula for realizing this operation by using opencv can be:

Down_input=cv2.resize(cv2.resize(input, w1,h1), w, h)*mouth_mask+input*(1-mouth_mask).

Herein, input is a BGR image with a pixel value range from 0 to 255, and the tooth region is mouth_mask with a pixel value range from 0 to 1.

According to the solution of the embodiment of the present disclosure, the blurring of the tooth region in a video stream or a low-resolution image is simulated. By limiting a range of downsampling, the blurring degree can be controlled to generate training samples with different difficulties, which helps the model learn multi-level restoration capabilities.

In a possible implementation, S113 of performing the image degradation processing on the tooth region of the sample face image by using at least one image degradation algorithm and the tooth mask to obtain the training image specifically includes:
performing JPEG encoding and then decoding on the tooth region of the sample face image by using the tooth mask to obtain a second tooth region image; and
obtaining the training image according to the second tooth region image and a non-tooth region of the sample face image.

In the embodiment of the present disclosure, JPEG encoding is performed on the tooth region image by using the tooth mask. In the encoding process, the image quality is adjusted by setting an image quality score parameter, which ranges from 0 to 100. The lower the score, the higher the compression rate and the more serious the image quality loss. In an example, the score may be set between 30 and 80.

The JPEG-encoded data is immediately decoded and restored to an image format to obtain the second tooth region image. This process introduces block artifacts and detail loss specific to JPEG compression.

The processed second tooth region image is spliced with the original non-tooth region to obtain the final training image.

In an example, the calculation formula for realizing this operation by using opencv can be:

Jpeg_input=cv2.imencode('. jpg', input, [int(cv2.IMWRITE_JPEG_QUALITY), quality])*mouth_mask+input*(1-mouth_mask),
where quality represents an image quality score with a reference value of 30<quality<80.

According to the solution of the embodiment of the present disclosure, the blurring and artifacts of tooth details caused by compression during image transmission over the Internet (such as WeChat and web page loading) are effectively simulated, so that the model has the ability to restore such a specific degraded image.

In a possible implementation, S113 of performing the image degradation processing on the tooth region of the sample face image by using at least one image degradation algorithm and the tooth mask to obtain the training image specifically includes:
superimposing a random noise on a pixel value of the tooth region of the sample face image by using the tooth mask to obtain a third tooth region image; and
obtaining the training image according to the third tooth region image and a non-tooth region of the sample face image.

In the embodiment of the present disclosure, a random noise matrix having the same size as the tooth region image is generated. An element (i.e., a random noise value) in the matrix is randomly extracted from a uniform distribution, and in an example, its value ranges from −30.0 to +30.0.

This noise matrix is superimposed on the pixel value of the tooth region image. In order to prevent an overflow of the pixel value (less than 0 or greater than 255), truncation processing is required to obtain the third tooth region image.

The processed third tooth region image is spliced with the original non-tooth region to obtain the final training image.

In an example, the calculation formula for realizing this operation by using opencv can be:

Noise_input=(noise+input). clip(0,255)*mouth_mask+input*(1-mouth_mask),
where noise represents random noise of 0-255, which may be random. uniform (−30.0,30.0).

According to the solution of the embodiment of the present disclosure, the random noise generated by an image sensor during shooting in a dark light environment is simulated, and the training model may learn to suppress noise while enhancing definition, so that the restoration result is cleaner.

In a possible implementation, S113 of performing the image degradation processing on the tooth region of the sample face image by using at least one image degradation algorithm and the tooth mask to obtain the training image includes:
subtracting a preset brightness value from a pixel value of the tooth region of the sample face image by using the tooth mask to obtain a fourth tooth region image; and
obtaining the training image according to the fourth tooth region image and a non-tooth region of the sample face image.

In the embodiment of the present disclosure, a preset brightness value which may range from 5 to 30, for example, is set. The preset brightness value is subtracted from the pixel value of the tooth region image. Truncation processing is also required to ensure that the pixel value is not lower than 0, so as to obtain the fourth tooth region image.

The processed fourth tooth region image is spliced with the original non-tooth region to obtain the final training image.

In an example, the calculation formula for realizing this operation by using opencv can be:

Black_input=(input-black). clip(0,255)*mouth_mask+input*(1-mouth_mask),
where black represents a color reduction range with a reference frame of 5<black<30.

According to the solution of the embodiment of the present disclosure, the situation of dark and yellow teeth caused by insufficient light or inaccurate exposure can be simulated, so that the model can not only improve the definition, but also learn tooth whitening and brightening capabilities to a certain degree.

In a possible implementation, S113 of performing the image degradation processing on the tooth region of the sample face image by using at least one image degradation algorithm and the tooth mask to obtain the training image specifically includes:
performing Gaussian blur processing on the tooth region of the sample face image by using the tooth mask to obtain a fifth tooth region image; and
obtaining the training image according to the fifth tooth region image and a non-tooth region of the sample face image.

In the embodiment of the present disclosure, a Gaussian filter is applied to the tooth region image. The kernel size and standard deviation of the filter can be set to different values to produce different degrees of smoothing and blurring effects, so as to obtain the fifth tooth region image.

The processed fifth tooth region image is spliced with the original non-tooth region to obtain the final training image.

In an example, the calculation formula for realizing this operation by using opencv can be:

Gauss_input=cv2.GaussianBlur(input)*mouth_mask+input*(1-mouth_mask).

According to the solution of the embodiment of the present disclosure, the model can be effectively trained to restore the problems of blurred tooth texture and edge caused by out-of-focus.

In a possible implementation, the tooth beautification model adopts a U-Net structure, and the U-Net structure includes a downsampling part for feature extraction and an upsampling part for image reconstruction which are symmetrical.

The U-Net structure further includes a skip connection for splicing a feature map of the downsampling part to a corresponding feature map of the upsampling part.

In the embodiment of the present disclosure, in addition to the symmetric downsampling (encoder) and upsampling (decoder) parts as mentioned above, the U-Net structure further has the skip connection. The skip connection is a shortcut established between the encoder and the decoder. Specifically, it directly copies and splices the feature map output by each scale (or level) during the downsampling of the encoder onto the feature map after upsampling with the corresponding scale in the decoder.

The skip connection allows the decoder to simultaneously utilize deep and abstract semantic information from the bottom of the encoder and low-level information from the shallow layer of the encoder that is directly transmitted through the skip connection and contains rich spatial and texture details when reconstructing the image.

According to the solution of the embodiment of the present disclosure, the fusion of high-level and low-level features greatly alleviates the loss of spatial information caused in the downsampling process, so that the model can reconstruct teeth with clear edges and realistic details.

In a possible implementation, the number of convolutional layers in the downsampling part or deconvolutional layers in the upsampling part is not more than 2.

In the embodiment of the present disclosure, in order to realize a lightweight tooth beautification model that can perform real-time inference on a mobile device or a general CPU, the network depth of the U-Net model is limited in this embodiment. Specifically, in a convolutional block of the downsampling part, the number of convolutional layers is not more than 2; similarly, in a deconvolutional block of the upsampling part, the number of deconvolutional layers is not more than 2. Meanwhile, the total number of downsampling or upsampling layers of the entire model can be correspondingly reduced.

According to the solution of the embodiment of the present disclosure, by limiting the network depth and the number of convolutional/deconvolutional layers per layer, the total number of parameters and computational complexity of the model can be significantly reduced. This directly brings two benefits, where first, the time and computing resources required for model training are less; second, the trained model has a small volume and fast inference speed, can meet application scenarios with strict requirements for low delay such as video live streaming and real-time beauty, and has higher practical value and deployment convenience.

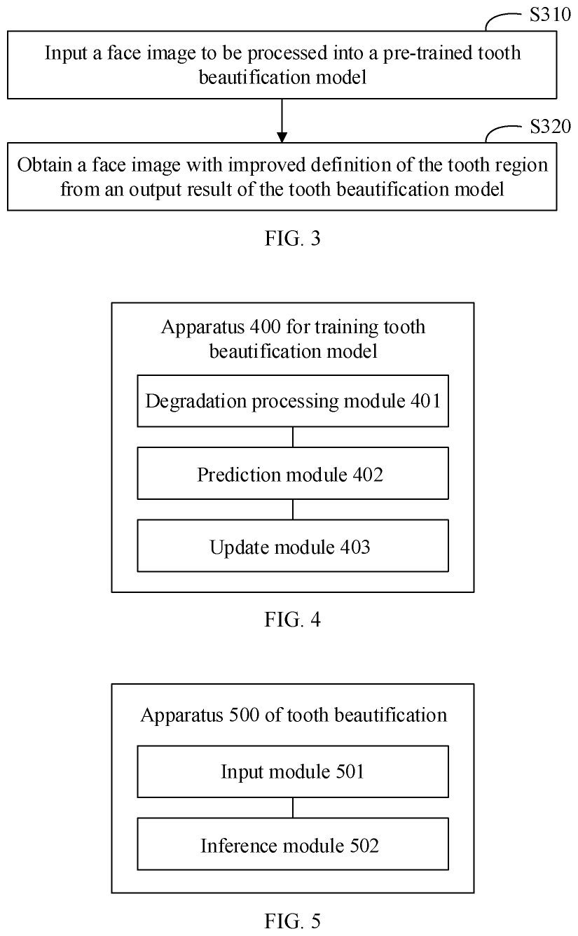

FIG. 3 is a schematic flowchart of a method of lightweight tooth beautification based on deep learning according to an embodiment of the present disclosure. As shown in FIG. 3, the method includes at least steps of:
S310: inputting a face image to be processed into a pre-trained tooth beautification model; and
S320: obtaining a face image with improved definition of the tooth region from an output result of the tooth beautification model,
where the tooth beautification model is trained and obtained by the method of model training according to any embodiment of the present disclosure.

FIG. 4 is a structural schematic diagram of an apparatus for training a tooth beautification model according to an embodiment of the present disclosure. As shown in FIG. 4, the apparatus 400 includes:
a degradation processing module 401, configured to apply at least one image degradation algorithm to a tooth region of a sample face image to obtain a training image, where a definition of the tooth region of the sample face image is higher than a definition of a tooth region of the training image;
a prediction module 402, configured to input the training image into a neural network model having a symmetric encoder-decoder structure to output a beautified face image, where the neural network model performs downsampling on the training image through an encoder path to extract a feature, and then performs upsampling on the feature through a decoder path to reconstruct; and an update module 403, configured to iteratively update a parameter of the neural network model according to a difference between the sample face image and the beautified face image to obtain the tooth beautification model.

In a possible implementation, the degradation processing module 401 is configured to:
acquire a high-quality face image including a clear tooth as the sample face image;
generate a tooth mask according to the tooth region of the sample face image; and
perform image degradation processing on the tooth region of the sample face image by using at least one image degradation algorithm and the tooth mask to obtain the training image.

In a possible implementation, the degradation processing module 401 is configured to:
determine a mouth key point region from the sample face image through face key point detection; and
segment a tooth part within the mouth key point region to obtain the tooth mask.

In a possible implementation, the image degradation algorithm includes at least one of:
Gaussian blur, downsampling processing, JPEG compression processing, noise processing or color reduction processing.

In a possible implementation, the degradation processing module 401 is configured to:
reduce a size of the tooth region of the sample face image from an original size to a preset size through downsampling by using the tooth mask;
restore the size to the original size through upsampling to obtain a first tooth region image; and
obtain the training image according to the first tooth region image and a non-tooth region of the sample face image.

In a possible implementation, the degradation processing module 401 is configured to:
perform JPEG encoding and then decoding on the tooth region of the sample face image by using the tooth mask to obtain a second tooth region image; and
obtain the training image according to the second tooth region image and a non-tooth region of the sample face image.

In a possible implementation, the degradation processing module 401 is configured to:
superimpose a random noise on a pixel value of the tooth region of the sample face image by using the tooth mask to obtain a third tooth region image; and
obtain the training image according to the third tooth region image and a non-tooth region of the sample face image.

In a possible implementation, the degradation processing module 401 is configured to:
subtract a preset brightness value from a pixel value of the tooth region of the sample face image by using the tooth mask to obtain a fourth tooth region image; and
obtain the training image according to the fourth tooth region image and a non-tooth region of the sample face image.

In a possible implementation, the degradation processing module 401 is configured to:
perform Gaussian blur processing on the tooth region of the sample face image by using the tooth mask to obtain a fifth tooth region image; and
obtain the training image according to the fifth tooth region image and a non-tooth region of the sample face image.

In a possible implementation, the tooth beautification model adopts a U-Net structure, and the U-Net structure includes a downsampling part for feature extraction and an upsampling part for image reconstruction which are symmetrical.

The U-Net structure further includes a skip connection for splicing a feature map of the downsampling part to a corresponding feature map of the upsampling part.

In a possible implementation, the number of convolutional layers in the downsampling part or deconvolutional layers in the upsampling part is not more than 2.

For the specific functions and example descriptions of each module and sub-module of the apparatus in embodiments of the present disclosure, reference may be made to the relevant descriptions of corresponding steps in the above method embodiments, and details thereof are not described herein again.

FIG. 5 is a structural schematic diagram of an apparatus of lightweight tooth beautification based on deep learning according to an embodiment of the present disclosure. As shown in FIG. 5, the apparatus 500 includes:
an input module 501, configured to input a face image to be processed into a pre-trained tooth beautification model; and
an inference module 502, configured to obtain a face image with improved definition of the tooth region from an output result of the tooth beautification model,
where the tooth beautification model is trained and obtained by the method of model training according to any embodiment of the present disclosure.

For the specific functions and example descriptions of each module and sub-module of the apparatus in embodiments of the present disclosure, reference may be made to the relevant descriptions of corresponding steps in the above method embodiments, and details thereof are not described herein again.

In the technical solution of the present disclosure, the collection, storage and application of user personal information involved comply with the provisions of relevant laws and regulations and do not violate public order and good customs.

According to embodiments of the present disclosure, the present disclosure also provides an electronic device, a readable storage medium and a computer program product.

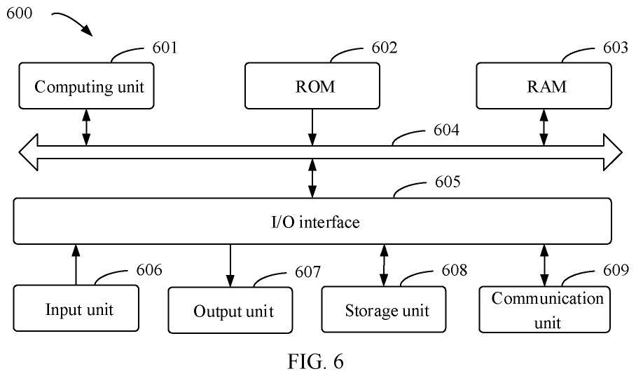

FIG. 6 shows a schematic block diagram of an exemplary electronic device 600 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar electronic devices. The components shown herein, their connections and relationships, and their functions are merely examples, and are not intended to limit the implementation of the present disclosure described and/or required herein.

As shown in FIG. 6, the device 600 includes a computing unit 601 that may perform various appropriate actions and processes according to a computer program stored in a Read-Only Memory (ROM) 602 or a computer program loaded from a storage unit 608 into a Random Access Memory (RAM) 603. Various programs and data required for an operation of device 600 may also be stored in the RAM 603. The computing unit 601, the ROM 602 and the RAM 603 are connected to each other through a bus 604. The input/output (I/O) interface 605 is also connected to the bus 604.

A plurality of components in the device 600 are connected to the I/O interface 605, and include an input unit 606 such as a keyboard, a mouse, or the like; an output unit 607 such as various types of displays, speakers, or the like; the storage unit 608 such as a magnetic disk, an optical disk, or the like; and a communication unit 609 such as a network card, a modem, a wireless communication transceiver, or the like. The communication unit 609 allows the device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 601 performs various methods and processing described above, such as the above the method for training tooth beautification model or method of tooth beautification. For example, in some implementations, the above method for training tooth beautification model or method of tooth beautification may be implemented as a computer software program tangibly contained in a computer-readable medium, such as the storage unit 608. In some implementations, a part or all of the computer program may be loaded and/or installed on the device 600 via the ROM 602 and/or the communication unit 609. When the computer program is loaded into RAM 603 and executed by the computing unit 601, one or more steps of the method for training tooth beautification model or method of tooth beautification described above may be performed. Alternatively, in other implementations, the computing unit 601 may be configured to perform the above method for training tooth beautification model or method of tooth beautification by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM) or a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for training a tooth beautification model, comprising:
applying at least one image degradation algorithm to a tooth region of a sample face image to obtain a training image, wherein a definition of the tooth region of the sample face image is higher than a definition of a tooth region of the training image;
inputting the training image into a neural network model having a symmetric encoder-decoder structure to output a beautified face image, wherein the neural network model performs downsampling on the training image through an encoder path to extract a feature, and then performs upsampling on the feature through a decoder path to reconstruct; and
iteratively updating a parameter of the neural network model according to a difference between the sample face image and the beautified face image to obtain the tooth beautification model.

2. The method of claim 1, wherein applying the at least one image degradation algorithm to the tooth region of the sample face image to obtain the training image, comprises:
acquiring a face image including a tooth region as the sample face image;
generating a tooth mask according to the tooth region of the sample face image; and
performing image degradation processing on the tooth region of the sample face image by using the at least one image degradation algorithm and the tooth mask to obtain the training image, wherein a definition of a tooth region of a reference face image is higher than the definition of the tooth region of the training image.

3. The method of claim 2, wherein generating the tooth mask according to the tooth region of the sample face image, comprises:
determining a mouth key point region from the sample face image through face key point detection; and
segmenting a tooth part within the mouth key point region to obtain the tooth mask.

4. The method of claim 1, wherein the image degradation algorithm comprises at least one of:
Gaussian blur, downsampling processing, JPEG compression processing, noise processing or color reduction processing.

5. The method of claim 2, wherein performing the image degradation processing on the tooth region of the sample face image by using the at least one image degradation algorithm and the tooth mask to obtain the training image, comprises:
reducing a size of the tooth region of the sample face image from an original size to a preset size through downsampling by using the tooth mask;
restoring the size to the original size through upsampling to obtain a first tooth region image; and
obtaining the training image according to the first tooth region image and a non-tooth region of the sample face image.

6. The method of claim 2, wherein performing the image degradation processing on the tooth region of the sample face image by using the at least one image degradation algorithm and the tooth mask to obtain the training image, comprises:
performing JPEG encoding and then decoding on the tooth region of the sample face image by using the tooth mask to obtain a second tooth region image; and
obtaining the training image according to the second tooth region image and a non-tooth region of the sample face image.

7. The method of claim 2, wherein performing the image degradation processing on the tooth region of the sample face image by using the at least one image degradation algorithm and the tooth mask to obtain the training image, comprises:
superimposing a random noise on a pixel value of the tooth region of the sample face image by using the tooth mask to obtain a third tooth region image; and
obtaining the training image according to the third tooth region image and a non-tooth region of the sample face image.

8. The method of claim 2, wherein performing the image degradation processing on the tooth region of the sample face image by using the at least one image degradation algorithm and the tooth mask to obtain the training image, comprises:
subtracting a preset brightness value from a pixel value of the tooth region of the sample face image by using the tooth mask to obtain a fourth tooth region image; and
obtaining the training image according to the fourth tooth region image and a non-tooth region of the sample face image.

9. The method of claim 2, wherein performing the image degradation processing on the tooth region of the sample face image by using the at least one image degradation algorithm and the tooth mask to obtain the training image, comprises:
performing Gaussian blur processing on the tooth region of the sample face image by using the tooth mask to obtain a fifth tooth region image; and
obtaining the training image according to the fifth tooth region image and a non-tooth region of the sample face image.

10. The method of claim 1, wherein the tooth beautification model adopts a U-Net structure, and the U-Net structure comprises a downsampling part for feature extraction and an upsampling part for image reconstruction which are symmetrical; and
the U-Net structure further comprises a skip connection for splicing a feature map of the downsampling part to a corresponding feature map of the upsampling part.

11. The method of claim 1, wherein a number of convolutional layers in the downsampling part or deconvolutional layers in an upsampling part is not more than 2.

12. A method of lightweight tooth beautification based on deep learning, comprising:
inputting a face image to be processed into a pre-trained tooth beautification model; and
obtaining a face image with improved definition of the tooth region from an output result of the tooth beautification model,
wherein the tooth beautification model is trained and obtained according to the training method of claim 1.

13. An electronic device, comprising:
at least one processor; and
a memory connected in communication with the at least one processor;
wherein the memory stores an instruction executable by the at least one processor, and the instruction, when executed by the at least one processor, enables the at least one processor to execute:
applying at least one image degradation algorithm to a tooth region of a sample face image to obtain a training image, wherein a definition of the tooth region of the sample face image is higher than a definition of a tooth region of the training image;
inputting the training image into a neural network model having a symmetric encoder-decoder structure to output a beautified face image, wherein the neural network model performs downsampling on the training image through an encoder path to extract a feature, and then performs upsampling on the feature through a decoder path to reconstruct; and
iteratively updating a parameter of the neural network model according to a difference between the sample face image and the beautified face image to obtain the tooth beautification model.

14. The electronic device of claim 13, wherein the instruction, when executed by the at least one processor, enables the at least one processor to execute applying the at least one image degradation algorithm to the tooth region of the sample face image to obtain the training image, by:
acquiring a face image including a tooth region as the sample face image;
generating a tooth mask according to the tooth region of the sample face image; and
performing image degradation processing on the tooth region of the sample face image by using the at least one image degradation algorithm and the tooth mask to obtain the training image, wherein a definition of a tooth region of a reference face image is higher than the definition of the tooth region of the training image.

15. The electronic device of claim 13, wherein the instruction, when executed by the at least one processor, enables the at least one processor to execute generating the tooth mask according to the tooth region of the sample face image, by:
determining a mouth key point region from the sample face image through face key point detection; and
segmenting a tooth part within the mouth key point region to obtain the tooth mask.

16. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 12.

17. A non-transitory computer-readable storage medium storing a computer instruction thereon, wherein the computer instruction is used to cause a computer to execute:
applying at least one image degradation algorithm to a tooth region of a sample face image to obtain a training image, wherein a definition of the tooth region of the sample face image is higher than a definition of a tooth region of the training image;
inputting the training image into a neural network model having a symmetric encoder-decoder structure to output a beautified face image, wherein the neural network model performs downsampling on the training image through an encoder path to extract a feature, and then performs upsampling on the feature through a decoder path to reconstruct; and
iteratively updating a parameter of the neural network model according to a difference between the sample face image and the beautified face image to obtain the tooth beautification model.

18. The non-transitory computer-readable storage medium of claim 17, wherein the computer instruction is used to cause the computer to execute applying the at least one image degradation algorithm to the tooth region of the sample face image to obtain the training image, by:
acquiring a face image including a tooth region as the sample face image;
generating a tooth mask according to the tooth region of the sample face image; and
performing image degradation processing on the tooth region of the sample face image by using the at least one image degradation algorithm and the tooth mask to obtain the training image, wherein a definition of a tooth region of a reference face image is higher than the definition of the tooth region of the training image.

19. The non-transitory computer-readable storage medium of claim 17, wherein the computer instruction is used to cause the computer to execute generating the tooth mask according to the tooth region of the sample face image, by:
determining a mouth key point region from the sample face image through face key point detection; and
segmenting a tooth part within the mouth key point region to obtain the tooth mask.

20. A non-transitory computer-readable storage medium storing a computer instruction thereon, wherein the computer instruction is used to cause a computer to execute the method of claim 12.
